(19) United States
(12) Patent Application Publication
(10) Pub. No.: US 2008/0228498 A1
(43) Pub. Date: Sep. 18, 2008

(54) Enhanced coordinated signal generation apparatus

(76) Inventor: Samuel N. Gasque, Hendersonville, NC (US)

Correspondence Address: GREGORY SMITH & ASSOCIATES, 3900 NEWPARK MALL ROAD, 3RD FLOOR, NEWARK, CA, 94560, US

(21) Appl. No.: 12/077,061

(22) Filed: Mar. 14, 2008

Related U.S. Application Data
(63) Continuation-in-part of application No. 11/196,130, filed on Aug. 2, 2005.
Application No. 11/196,130 is a continuation-in-part of application No. 11/182,509, filed on Jul. 15, 2005.
(60) Provisional application No. 60/918,346, filed on Mar. 15, 2007.
(60) Provisional application No. 60/598,291, filed on Aug. 2, 2004.
(60) Provisional application No. 60/588,855, filed on Jul. 15, 2004.

(51) Int. Cl. G10L 21/06

(52) U.S. Cl. 704/276; 704/E11.001

(57) ABSTRACT

A portable information system that, when activated, presents certain data to a user, wherein the information is prepositioned within the portable system or provided to it. The information may be resident within fixed memory, added by means of a smart card, or wirelessly transmitted to the information system. The information conveyed to the user may be visual, such as a text screen or a video display as well as audible such as a play by play broadcast. The information may include local areas of interest or locations within the venue in which the apparatus is used.

### CROSS REFERENCE TO RELATED APPLICATIONS

This application claims the benefit of the priority date of provisional patent application Ser. No. 60/918,346. This application is also a continuation-in-part of utility patent application Ser. No. 11/196,130, which claims the benefit of the priority date of provisional patent application Nos. 60/598,291 and 60/588,855, and which utility patent application Ser. No. 11/196,130 is further a continuation-in-part of utility patent application Ser. No. 11/182,509 which claims the benefit of the priority date of provisional application Ser. No. 60/588,855. The applications listed above are all hereby incorporated by reference in their entirety.

### BACKGROUND

Part of the experience of sports fans comes from cheers, yells, acclamation and loud noise, and visual displays. There is an unspoken feeling that the louder the clamor the better chance of victory for the team. Sports fans from many generations and many countries show their support for a team by having inanimate replicas of the team's mascot, yelling the sounds made by the mascot animal, and displaying visual banners of their team. This experience is very emotional and enjoyable for the fans. Coordinated displays, whether audible, visual, or otherwise enhance the feeling of a shared experience by sports fans.

Often, fans and booster clubs use noise making devices, such as bells, whistles, horns, drums, and megaphones. Air horns and electric power horns have been used. Such devices have been popular as demonstrated by the quantity of devices that have been purchased over the many years that sporting events have occurred. As is known in the art, electronic sounds have been produced by various products using a variety of technologies such as records, audio tapes, compact discs, and digital signals stored in electronic memory.

The evolution of technology has allowed the continual enhancement of the experience for enthusiasts. Public venues are providing more and more information, such as driving instructions, photos, video clips, scores, instant replays and the like. The new information is provided through media such as the internet, smart cards, wifi transmissions and text messages, to name a few. Location information is used to make the newly-available information more meaningful. Advertisers are beginning to support if not subsidize the new information. Generally, such information is available to the user at the user's personal computer or smart phone or presented throughout the venue.

What is needed is an inexpensive device that provides a means for displaying data of interest to the user of such a device. The enhanced, shared experience provides a new level of enjoyment for the user of the device and for the many fans at the sporting event.

### SUMMARY

The present invention includes a hand held apparatus that, when activated, generates displays or signals. The displays or signals may include sounds, visual effects, tactile effects, and others.

When multiple apparatuses are used, one apparatus and/or a central controller may coordinate the signals of other apparatuses in accordance with the present invention. Such embodiments may include the ability to detect and synchronize in response to a pre-determined timing with other associated apparatuses to create a coordination signal. The coordination signal may generate composite displays called signal events generated by the output of multiple similar apparatuses. In some embodiments, the signals coordinate the activity of users of a same or similar apparatus, so that a display results at least partly from actions by the users taken in response to coordinated signals from apparatus of the invention.

For example, an audible display may be generated by having a plurality of apparatuses emit the animal call of a team mascot or team song. If the sound is of a team mascot, the sound could be simultaneously generated by multiple apparatuses as a single loud call, or the apparatuses may sound independently to simulate the sound of a pack of such animals calling.

In some embodiments, the signal generating apparatus is able to produce an authentic animal sound, wherein the sound is loud enough to be heard by others in large gatherings. In another aspect of the invention, the signal generating apparatus also provides visual effects that may include at least a single light source and, in alternate embodiments, further include moving light sources such as rotating beacons, flat images, or three dimensional images. In other embodiments an apparatus in accordance with the invention generates tactile outputs experienced by the user holding or wearing the apparatus. Such tactile feeling may be a simple vibration, or motion of certain indentations/dimples that can be felt. In still further embodiments, the signal generating apparatus is capable of generating odors, some odors being, but not limited to pleasing odors (“the sweet smell of victory”) when the team is winning, and noxious odors when the team is losing.

In still another aspect of the invention, the signal generating apparatus recognizes the presence of other such apparatus in its proximity and operates in a coordinated fashion.

In some embodiments the invention utilizes a microprocessor-controlled RF circuit for synchronization purposes. The signal generating apparatus also may have an adjustable volume control and may comfortably fit in the palm of the operator's hand. In some embodiments the invention operates using a portable battery supply that is able to last throughout a complete game including any overtime activity. In some embodiments the apparatus is housed in a durable and weatherproofed enclosure providing protection in the event of bad weather.

In yet another aspect of the invention, the signal generating apparatus is controlled from a centralized controller that affects the entire venue, providing the ability to deactivate some or all signal generating apparatuses when authorities so require, activate some or all signal generating apparatuses when deemed appropriate, or act as a synchronization source to coordinate the activities of some or all signal generating apparatuses.

Additional user features may be provided or enabled by removable memory, wireless transmission, IR data from a PDA, and codes entered on a keypad, for example. In some embodiments prepositioned or additional data is used by a GPS device to provide location and routing instructions. Other embodiments provide access to and use of individualized (or group-specific) information. Examples include driving instructions for the user, the instructions having been downloaded from the internet onto a USB FOB memory or smart card. In some embodiments encrypted data is stored in the signal generating apparatus, the data later transmitted at an entry point in lieu of a paper ticket. Smart cards or other accessory memories may be offered to enable certain experience-enhancing functions, such as digital photography with a person use license.

The invention includes methods. In one example method for coordinating the actions of a group of people to create a coordinated signal event, the steps include: (a) providing two or more people with a signal generating apparatus capable of emitting one or more signals, and also capable of emitting communications to other signal generating apparatuses, (b) having one person activate one of the signal generating apparatus to emit a communication that may be received by other signal generating apparatuses, (c) receiving the communication by a signal generating apparatus wherein each initiates a timing in response to receiving the communication, and (d) emitting at least one signal from each of signal generating apparatus in accordance with the timing.

In some embodiments the composite signal from the signal generating apparatuses creates a coordinated signal event. In other embodiments, the signals emitted are intended to prompt users to perform one or more actions, for example, physical motions or a shout or song. Thus the coordinated signal event is created by the actions of the users in response to the signals from the signal generating apparatus.

Another embodiment of the invention includes a GPS module which provides routing information used to get to the stadium or sports facility where the sporting event will be held, and also routing information within the stadium or sports facility to assist the user in finding their seat.

Some devices built in accordance with the invention are capable of receiving audio and or visual transmissions and presenting the transmissions visually or audibly to the user.

Another embodiment of the invention includes a cradle or docking station into which a hand held electronic device such as a telephone, digital music player, digital video player personal digital assistance, or the like may be plugged. The combined hand held device and cradle together can then be used like the device embodiments described above to provide the functionality described above, preferably where neither the hand held electronic device nor the cradle alone provides all of the desired functionality.

### BRIEF DESCRIPTION OF THE DRAWINGS

FIG. 1 is a block diagram of the system components according to the present invention.

FIG. 2 is a block diagram of an example sonic output system.

FIG. 3 is a block diagram of an example providing a visual display.

FIG. 4 is a block diagram of an example providing an odor sub-system.

FIG. 5 is a block diagram of an example providing tactile signals to a user.

FIG. 6 is a block diagram of an example system further including a GPS module.

FIG. 7 is a block diagram of a system which may receive signals form one or more sources.

FIG. 8 is a block diagram of an example system created by coupling a hand held electronic device with a cradle.

FIG. 9 is a block diagram of exemplary external accessories which may be used in association with the system of the present invention.

FIG. 10 is a flow chart of a method for coordinating the activities of a plurality of units of the present invention.

### DESCRIPTION OF SOME EMBODIMENTS

### Definition of Some Terms

| | |
|---|---|
| GPS | Global Positioning System. A system for determining the |
| | position on the earth of a receiving instrument. |
| RF | Radio Frequency waves. |
| DAC | An electronic Digital to Analog Converter device. |
| LCD | Liquid Crystal Display. |
| IR | Infra-red light. Used in bit patterns to transmit digital |
| | data to an IR receiver. |
| wifi | A wireless local area network system, compliant with the |
| | 801.11 specification. |
| smart card | A memory device, often embedded within a thin credit |
| | card sized carrier, which may be loaded with data. |
| | Some include processing and/or security capabilities. |
| key fob | A small security hardware device with built-in |
| | authentication used to control and secure access |
| | to network services and data. |

The present invention includes devices for generating displays or signals for use by sports fans and booster clubs in support of their teams. Some displays are coordinated displays as described further below. The invention may further include a mobile device that uses GPS data for routing information relating to events attended by the user, and combinations of electronic devices and cradles that together provide such functionality. Other embodiments provide optional features which are specific to a location and/or time of use. Some embodiments provide means for an individual signal generating unit to provide optional features, either by configuration or by signals from a master controller.

The present invention includes a signal generating apparatus which is a novelty device that is adapted to generate signals and when more than one signal generating apparatus is used, may detect the presence of other such apparatuses and participate in generating coordinated displays. Coordinated displays or signals as used herein include signals from two or more signal generating apparatuses including any combination of signal types having a timing and duration that are synchronized or timed to produce a desired signal event.

In some embodiments, the generated signals serve the purpose of coordinating activity by the users of other signal generating apparatuses, so that a display results at least partly from actions by the users taken in response to coordination signals. The coordination signals may be from apparatus according to the present invention or by other means. The displays or signals may include sounds, visual effects, tactile effects, and others.

In some embodiments, the signal generating apparatus produces audible displays loud enough to be heard by others in large gatherings. For example an apparatus of the invention may be configured to generate an animal sound, for example, the sound or call of a sports team's mascot. When more than one apparatus is used, the apparatus may further be able to synchronize with other apparatuses in the local area to create a coordinated sound. For example, the signal generating apparatus may be able mimic a pack of wolves calling at the same time. In another embodiment, a “rival switch” may be present on the signal generating apparatus to be activated by the user. Since the user desires to support his team by the generation of sounds by the signal generating apparatus, the user may also wish to antagonize the opposing team through the use of signal events. When activated, the rival switch produces a sound that mocks the opposing team. For example, if a rival team has a tiger for its mascot, the mascot would normally produce a loud roaring sound. The signal generating apparatus with the rival switch activated may produce the sound of a kitten or a tiger in distress.

In another aspect of the invention, the signal generating apparatus is able to produce visual effects that may include at least a single light source and, in alternate embodiments, includes moving light displays such as rotating beacons, flat images, three dimensional images, or other graphics.

In other embodiments, an apparatus in accordance with the invention generates tactile outputs sensed by the user holding or wearing the apparatus. Such tactile feeling may be a simple vibration, or motion of certain indentations/dimples that can be felt. In still further embodiments, the apparatus is capable of generating odors, some odors being, but not limited to, pleasing odors (“the sweet smell of victory”) when the team is winning, and unpleasant odors when the team is losing.

In some embodiments, the signal generated by the signal generating apparatus is used to coordinate a display generated by movement of the users of the sound generating apparatus. For example, a signal may propagate among signal generating apparatuses providing a signal to each user of such device that the user should perform a wave motion. The motion of large groups of fans may be choreographed in this way.

Embodiments of the invention discussed in detail below are provided as examples meant to be used generally in sports environments. Alternate embodiments include, but are not limited to, applications in hunting, exercising, zoos, wildlife, toys for children, and law enforcement uses.

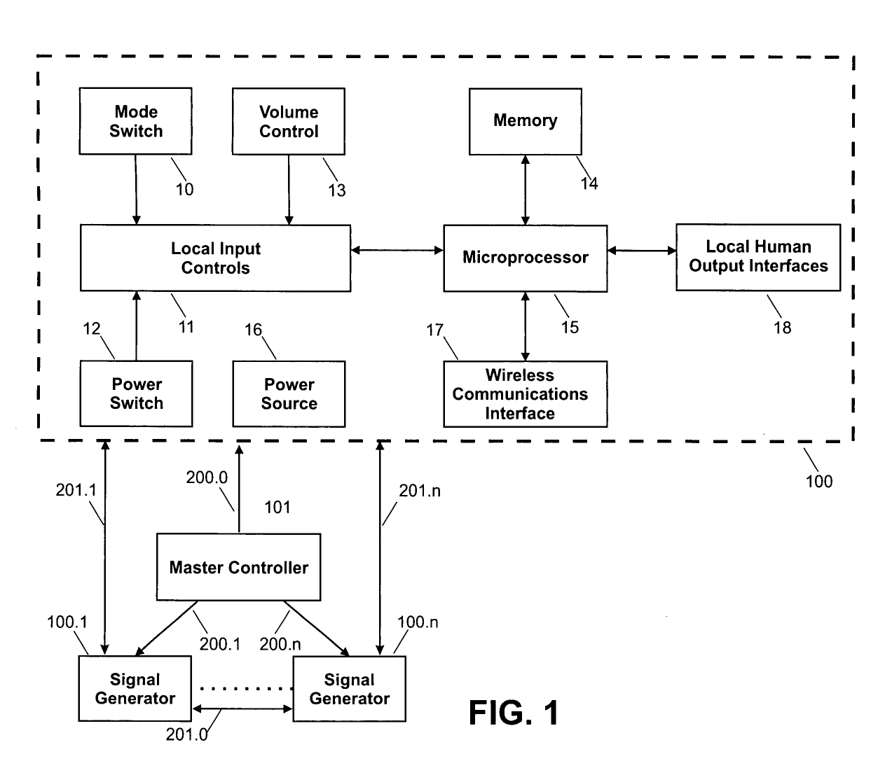

Internal workings of the signal generating apparatus may include but is not limited to electronic circuitry including printed circuit boards, silicon chip devices, and electro-mechanical devices. Referring to FIG. 1, the general components of a system of the present invention are signal generating apparatus 100 and one or more compatible signal generating apparatuses shown as 100.n, where “n” is the number of compatible signal generating apparatuses similar to signal generating apparatus 100. Signal generating apparatus 100 and signal generating apparatus 102.1 are able to wirelessly identify the presence of at least some of other apparatus 100.n, if any are present. The generating apparatuses 100.n communicate with each other via signals 201.0 through 201.n.

In the description to follow we may use the plural and the singular interchangeably for convenience; the reader will understand that the reference 100.n indicates a one or more apparatus apart from the single apparatus 100. An apparatus referred to as an apparatus 100 may also be included in use of the term apparatuses 100.n. Said differently, element 100 in FIG. 1 is simply a more detailed example of any of elements 100.1 through 100.n.

In an alternate embodiment, a master controller 101 is present at a certain venue, providing event supervisors the ability to enable, disable, synchronize, or selectively control all such signal generating apparatuses 100.n. Although there is no requirement for a master controller 101 to be present to make use of the present invention, the added features enabled by the master controller 101 add functionality to the system. For example, there may be times that event supervisors wish to have silence at the venue such as during the national anthem. The master controller 101 can be used to disable all such signal generating apparatuses and prevent an audio disturbance. Note that when master controller 101 is not used (or received) the units 100.n are configured to communicate with each other. Signals 200.n are paths between various units 100.n and master controller 101. However, signals are in common with all compatible units, thus may be between various 100.n units and the master controller 101 (i.e., 200.n and 201.n) simultaneously.

The wireless technology used for the identification of other signal generating apparatuses 100.n in the vicinity may be, but is not limited to, sonic, radio frequency (RF), or infrared (IR) technologies. In one embodiment the wireless technology allows for bidirectional communication between the apparatuses 100.n. In an alternate embodiment, uni-directional communication is used. Examples of useable wireless technologies include but are not limited to a form of IEEE 802.11, a form of Bluetooth, a form of IEEE 802.15, and a form of IEEE 802.16.

The operation of an example embodiment of the invention is as follows. A person wishing to express their exuberance for their team activates a function on signal generating apparatus 100 which creates a sound signal, for example a wolf howling. Signal generating apparatus 100 asynchronously sends a communication on communications paths 200.n indicating its (100) activation. Other signal generating apparatuses 100.n would recognize the communication sent wirelessly from signal generating apparatus 100 and also activate its (100.n) sound signal. The communication continues to be relayed in kind to other signal generating apparatuses 100.n. Thus many, ideally all (depending upon the instant reliability of communications between apparatuses 100.n) of the signal generating apparatuses 100.n creates compatible sound signals which together create the desired signal event. In another mode, various signal generating apparatuses 100.n vary the starting of their individual sound events such that the effect generated is similar to that of several individual wolves starting and stopping at differing times and producing slightly different sounds. Any useable methods for coordinating the signal events may be used in the invention. For example, when it is desired to initiate a single simultaneous sound event from signal generating apparatuses 100.n one method for synchronizing the sound events includes transmitting a signal from a signal generating apparatus 100 that is received by signal generating apparatuses 100.n, which causes all of the signal generating apparatuses 100.n to begin a sound event at the same time.

In an alternate embodiment, a sound event is enhanced by or replaced by a visual event such as activation of a light device. There is no requirement that all signal generating apparatuses posses the same capability for generating a sound event, visual event, or both events simultaneously. In one alternate embodiment, a signal generating apparatus posseses neither sound nor visual event capabilities but its presence allows for the signal generating apparatus 100.n to relay trigger messages between other signal generating apparatuses which do posses such capabilities.

The wireless technology used by master controller 101 to communicate with signal generating apparatuses 100.n and/or master controller 101 may be, but is not limited to, sonic, radio frequency (RF), or infrared (IR) technologies. The communication technology between signal generating apparatus 100 and its peer signal generating apparatuses 100.n is the same wireless technology as between signal generating apparatus 100 and master controller 101. In an alternate embodiment, the communication technology between signal generating apparatus 100 and its peer signal generating apparatuses 100.n is a different wireless technology than is used between signal generating apparatus 100 and master controller 101. In some embodiments the wireless technology from the master controller 101 is uni-directional, transmitting from the master controller 101 to the signal apparatuses 100.n. In an alternate embodiment, bidirectional communication is used.

In an embodiment where master controller 101 is present, the controller 101 controls the activation of the sound and visual events of all of the signal generating apparatuses at the venue. In an alternate embodiment the master controller 101 acts as a coordinator of the sound or visual events occurring in the plurality of signal generating apparatuses. Examples of such coordination are, but not limited to, sending a signal that initiates an action that moves progressively through the venue mimicking a “wave” action, having selected signal generating apparatuses 100.n activated to mimic a pack of mascots instead of a single unified mascot, or causing selected signal generating apparatuses to vary their output events differently from neighboring signal generating apparatuses 100.n. Similarly, a signal may propagate among signal generating apparatuses providing an alert to each user of such device that the user should perform a particular motion. The motion of large groups of enthusiasts may be choreographed in this way, creating an audible or visual display by the action of a large numbers of enthusiasts.

Still looking to FIG. 1, the major functional blocks within signal generating apparatus 100 that implement the features of the present invention include a local power source 16, microprocessor 15 that manages output events through a local human output interface 18 based on the user input received by a local input control 11, and also senses other external devices through messages provided by a wireless communications interface 17. Instructions (a program) for the microprocessor 15 are stored in a memory 14. The functional blocks are housed in a portable enclosure that may optionally be weatherproofed. The memory 14, in some embodiments, is a replaceable memory device, such as a smart card or key fob. In one embodiment memory 14 can be altered or added to by various means but not removed.

Sometimes memory 14 is augmented by replaceable memory, wherein the replaceable memory holds data and/or program patches specific to a location, time, or function. Sometimes the information is only available for a limited or selected period of time. In one embodiment the information of feature of interest to the user is prepositioned within the signal generating apparatus and is enabled or disabled by the replaceable memory or by data transmission. For example, in one embodiment of the present invention a smart card is sold (or rented) at a sporting event. The smart card provides for additional features, such as the display of scores around the league, play by play audio, videos of instant replays and such. In one embodiment the replaceable memory use is subsidized by advertisers.

Herein after, references to “memory 14” are understood to include a replacement, replaceable, or augmenting memory if provided.

Power source 16 may be a replaceable primary cell battery, a lead-acid battery, a fuel cell, a solar cell, RF signals, magnetic signals, optical signals, or any combination of power sources.

The local human output interface 18 comprises any of an optical output, sonic or sound output, or both a sound and optical output that can be sensed by a person. In an alternate embodiment where signal generating apparatus 100 acts as a relay device for wireless messages, local human output interfaces 18 may or may not be present. Control of these output interface technologies is available to the microprocessor through block 11 that connects to settings that may be altered by the user and/or master controller 101. Examples of such settings are, but are not limited to, a volume control, the type of output event, the sequencing of the output event, or selectable modes of operation.

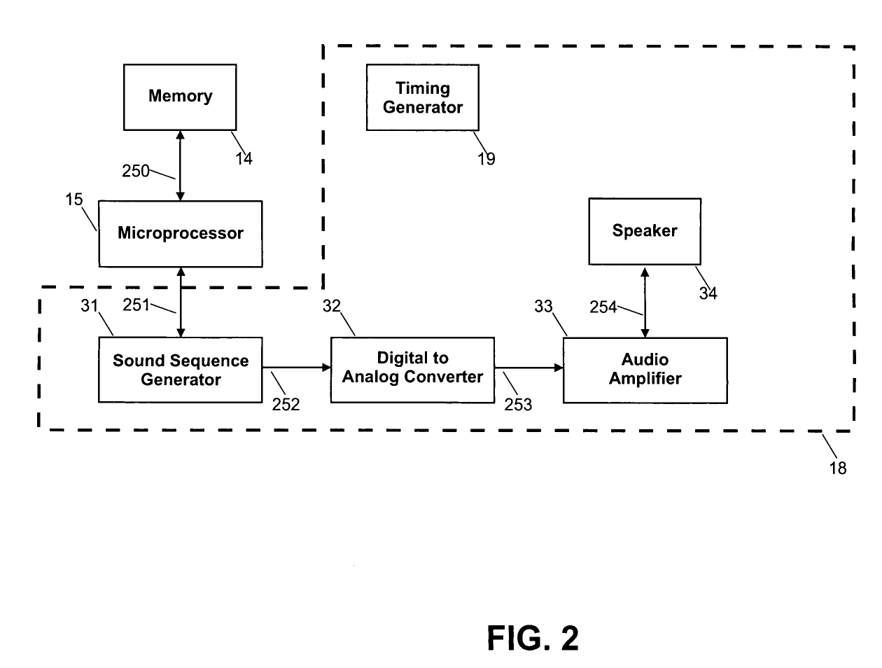

FIGS. 2 through 5 are examples of alternative embodiments of the local human output interface 18. Any one or all examples may be implemented into a given signal generator 100. For all of these, the described electronic waveform may be generated with sequences initiated over the communications path 251 by microprocessor 15 upon reading memory 14 over communications pathway 250. In alternate embodiments, the waveform is generated from information received from the wireless communications interface 17 (connection not shown).

An example schematic of a sound-producing version of the local human output interface 18 is shown in FIG. 2. An electronic sound sequence generator 31 creates an electronic waveform signal carried to an input terminal of a digital-to-analog converter (“DAC”) 32 by a line 252. An output signal of DAC 32 is carried by a line 253 to an input terminal of an audio amplifier 33. The audio amplifier 33 output is carried by a line 254 to a speaker 34. In some embodiments, the waveform is generated from information prepositioned within the sound sequence generator 31.

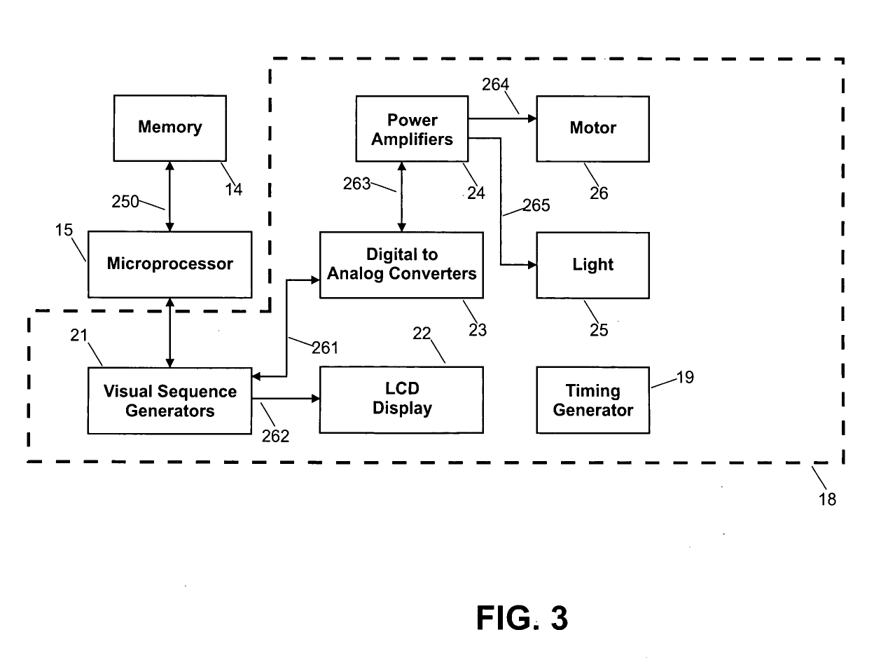

An example schematic of a visual version of the human output interface 18 is shown in FIG. 3. An electronic visual sequence generator 21 provides an electronic waveform, connected to an input terminal of digital-to-analog converters 23 by line 261. DAC 23 output signals are carried to input terminals of power amplifiers 24 by line(s) 263. An output signal from power amplifiers 24 is carried by a line 265 to an input terminal of a light 25. In an alternate embodiment, a motor 26 under the control of visual sequence generator 21 (through DAC 23 and power amplifier 24 on line 264) is adapted to mechanically drive light 25 to alter the visual effect of the light 25. In yet another alternate embodiment, a micro electro-mechanical systems (MEMS) device integrates the visual and mechanical block functions. In yet still other alternate embodiments, a more complex, visual image is available for the enjoyment of the users by viewing an LCD display 22. LCD display 22 is electrically connected to the visual sequence generator 21 by line(s) 262. Many suitable or useable technologies and methods for the visual sequence generator 21 will be known to one skilled in the art.

In one embodiment, the signal generating apparatus 100 is capable of providing odors, some odors being, but not limited to, pleasing odors (“the sweet smell of victory”) when the team is winning, and noxious odors when the team is losing.

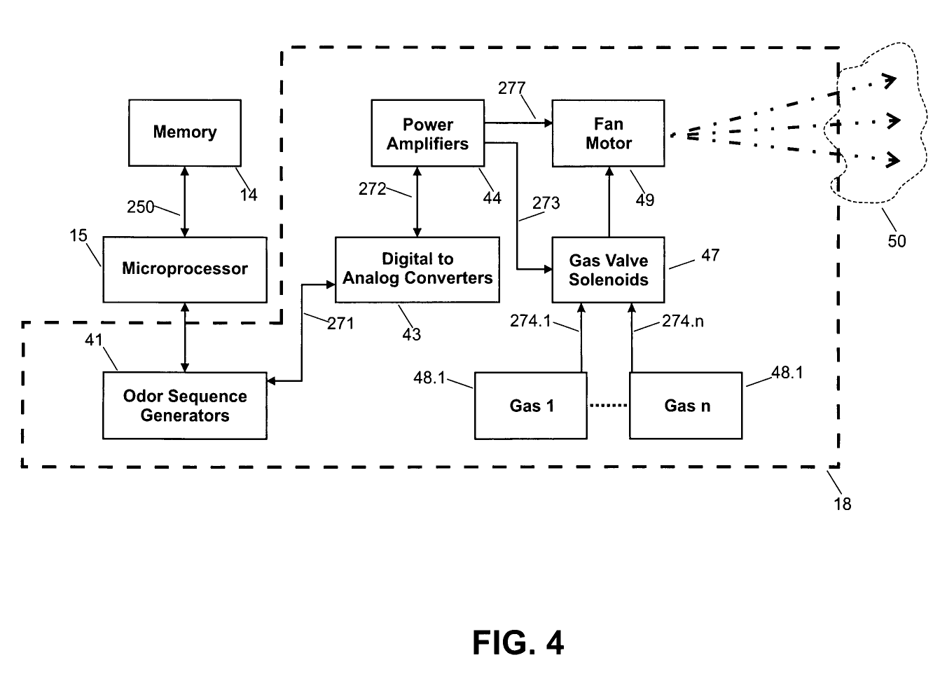

An example schematic of an order-producing version of the human output interface 18 is shown in FIG. 4. An electronic odor sequence generator 41 provides an electronic waveform that controls the ratios of various gases to provide different odors. The signal is carried to an input terminal of digital-to-analog converter 43 by line 271. DAC 43 output signal is carried to an input terminal of power amplifiers 44 by line 272. Power amplifiers 44 drive fan motor 49 via line 277 and gas valve solenoids 47 via bus line 273 to control the desired mixture of gases 48.n. Those with ordinary skill in the art will appreciate the variety of methods to implement the odor sequence generator 41. Note that the connections 274.n shown between gas canisters 48.n and the gas solenoids 47 are passageways for the gas to flow from the canisters, not an electronic connection. In alternate embodiments, the waveform is generated through information prepositioned within odor sequence generator 41, or in yet another alternate embodiment, information received from the wireless interface 17 (connection not shown). Such odors 50 are detected by the user when emitted from the signal generating apparatus.

In an alternate embodiment, gases 48.n are replaced by liquid fragrances to be mixed and emitted from the signal generating apparatus 100. The number of gas or liquid canisters within the signal generating apparatus 100 may change without departing materially from the teachings of the present invention.

In some circumstance, when a user of the signal generating apparatus 100 wants to receive information from other signal generating apparatuses 100.n or from the master controller 101, audio and visual cues may be difficult for the user to detect. Under these circumstances it may be beneficial for signal generating apparatus 100 to generate a tactile event that can be felt by the user. Such tactile event may be a simple vibration, or movement of certain indentations/dimples. Through such tactile events, organized actions of groups of signal generating apparatus 100 users can be coordinated.

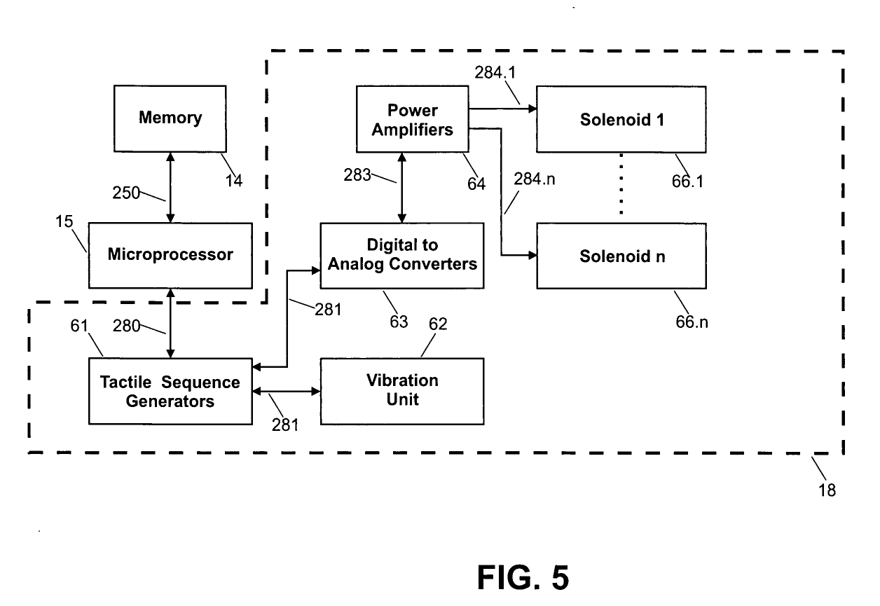

An example of a schematic for a tactile version of the human output interface 18 is shown in FIG. 5. An electronic tactile sequence generator 61 creates an electronic signal that controls the tactile event. The signal is carried to an input terminal of DAC 63 by line 281. DAC 63 output is carried to an input terminal of power amplifiers 64 by line 283. Power amplifiers 64 control the solenoids 66.n that allow the user to feel an event. Those with ordinary skill in the art will appreciate the variety of methods possible for solenoids 66.n to implement its function. The electronic waveform can be generated with sequences initiated over the communications path 280 by microprocessor 15 upon reading memory 14 over communications pathway 250. In alternate embodiments, the waveform is generated through information within tactile sequence generator 61, or in yet another alternate embodiment, information received from the wireless interface 17 (connection not shown). In one embodiment the tactile sequence generator 61 output terminal provides a signal carried by line 281 to an input terminal of a vibration unit 62. The vibrations are felt by the user when the vibration unit 62 is activated by the tactile sequence generator 61.

The signal generating apparatus 100 has various modes that trigger one or more of the above mentioned sonic, visual, smell, or tactile events. They can be manually activated, locally synchronized with neighboring units, or controlled from the master controller 101. Another mode in an alternate embodiment randomly triggers the signal generating apparatus 100 event. This mode has the unit activate at random without apparent cause and the surprise is deemed by the user to be interesting.

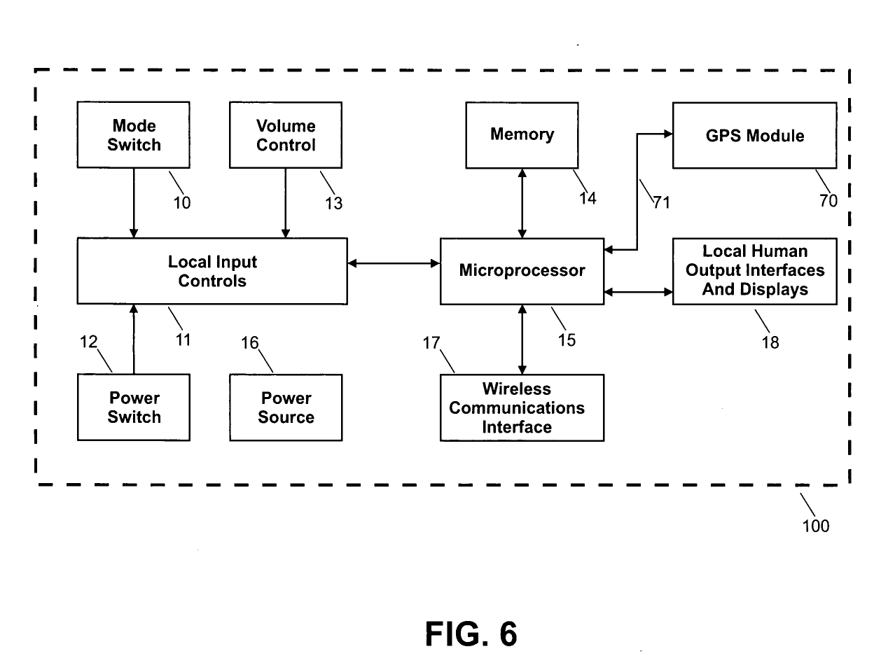

Referring to FIG. 6, another exemplary embodiment of the invention includes a GPS module 70 which may provide routing information to the viewer, used to get to the stadium or sports facility where the sporting event will be held, and also routing information within the stadium or sports facility to assist the user in finding their seat. The GPS module 70 provides position data signals to microprocessor 15 on line 71. The microprocessor accesses information prepositioned in the memory 14 or provided by wireless communications interface 17 as a function of the position information received from the GPS module 70 to provide routing information to the user. The data used in cooperation with the GPS 70 position data may also provide information about locations of interest including but not limited to hotels, restaurants and parking near the stadium or sports facility, and or the location of the user's seats, bathrooms, shops and food services within the stadium or sports facility. In one embodiment the information of interest is available for viewing without the GPS location information.

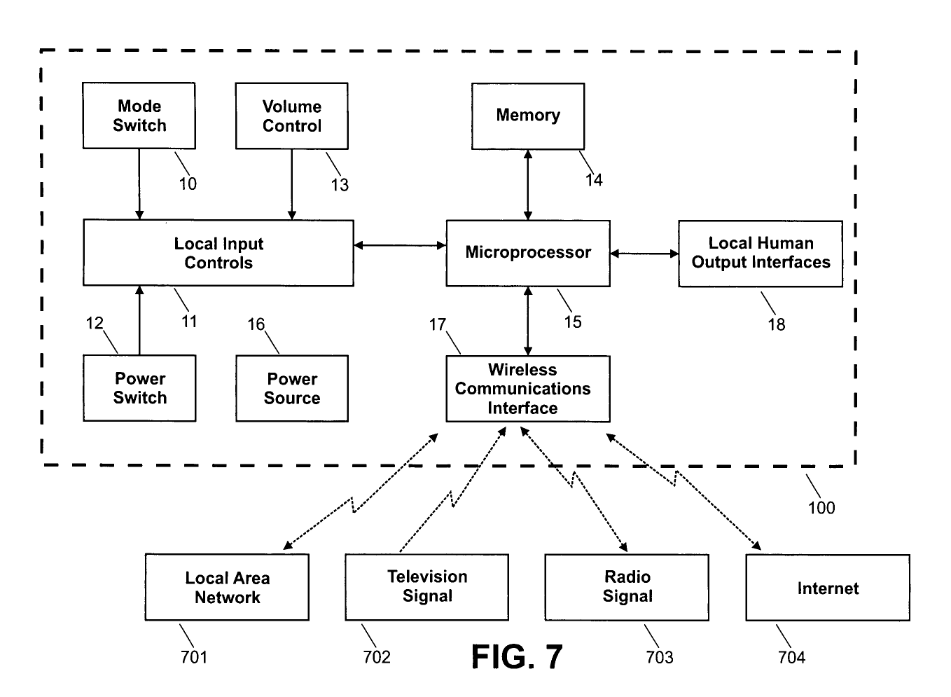

Referring to FIG. 7, some devices built in accordance with the invention receive audio and or visual transmissions and present the transmissions visually or audibly to the user. These transmissions may originate from data sources including but not limited to typical television 702 and radio stations 703, the stadium or sports facility, and or transmissions through a local area network 701 or the internet 704. The transmissions received may include but are not limited to sports news, replays, game information, messages, and advertising.

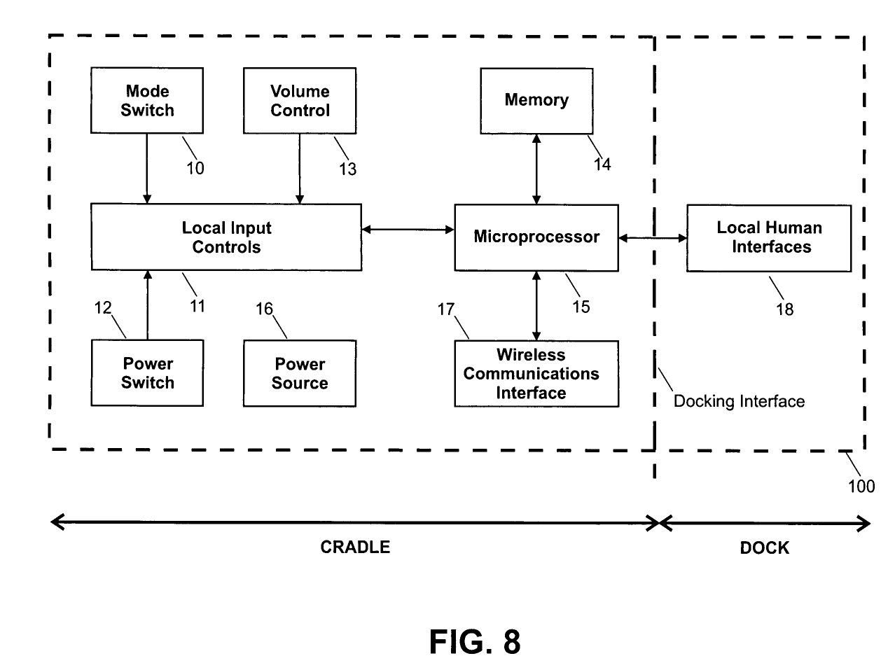

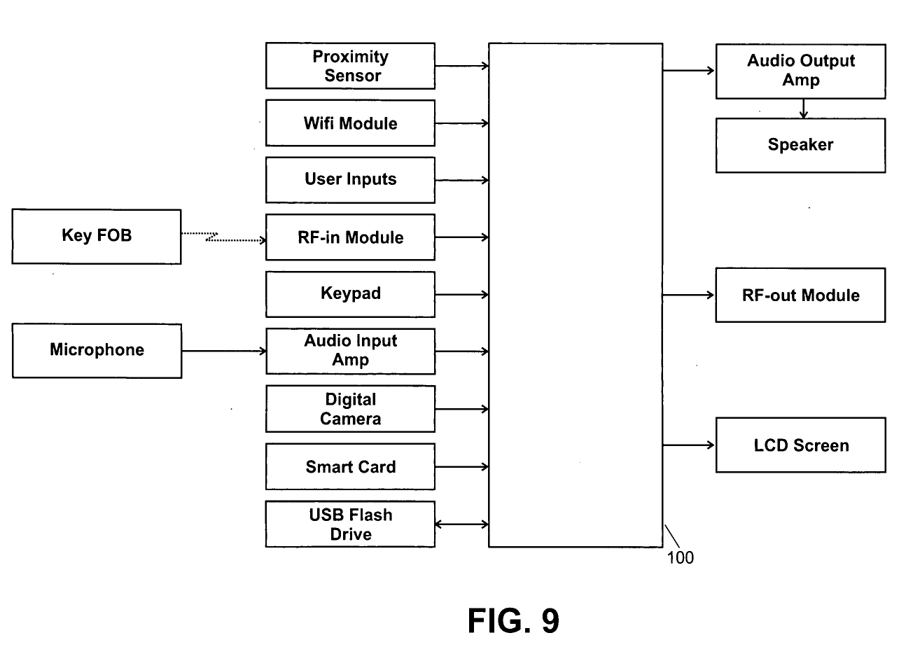

Other exemplary embodiments, as shown in FIG. 8 and FIG. 9, include a cradle or docking station into which a hand held electronic device such as a telephone, digital music player, digital video player personal digital assistance, wifi module, proximity sensor or the like may be plugged. The combined hand held device and cradle together can then be used like the device embodiments previously described herein to provide the functionality described above, where neither the hand held electronic device nor the cradle alone provides all of the desired functionality.

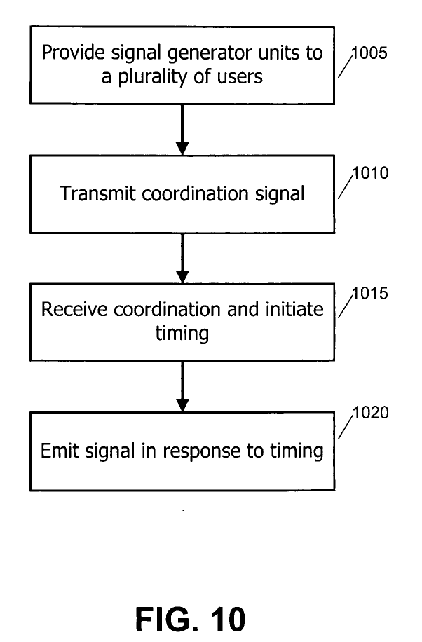

The invention includes methods. Referring to FIG. 10, in one example method for coordinating the actions of a group of people to create a coordinated signal event, the steps include (1005) providing two or more people with a signal generating apparatus capable of emitting one or more signals, and also capable of emitting communications to other signal generating apparatuses; (10010) having one person activate one of the signal generating apparatuses to emit a communication that may be received by other signal generating apparatuses; (1015) receiving the communication by other signal generating apparatuses with each initiating a timing in response to receiving the communication; and (1020) emitting at least one signal from each of signal generating apparatuses in accordance with the timing.

In some embodiments the composite signal from the signal generating apparatus 100 creates a coordinated signal event. In other embodiments, the signals emitted prompt users to perform one or more actions, for example, a motion or motions or a shout or a song. Thus the coordinated signal event is created by the actions of the users in response to the signals from the signal generating apparatus.

Devices built in accordance with the invention may or may not include all of the functionality described above. Specifically, embodiments of the invention may include only subsets of the functionality described above in a variety of combinations of such functionalities. For example, a device built in accordance with the invention may include all of the functionality listed above except that it might lack the ability to produce coordinated displays, but would still be capable of displaying video images and audio therefore.

Although exemplary embodiments of the invention have been described in detail above, those skilled in the art will readily appreciate that many additional modifications are possible without departing materially from the teachings and advantages of the invention. For example, the system may be used in hunting where the system can simulate the sounds of a heard of animals to lure an animal into a desired location.

### Resolution of Conflicts

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

What is claimed is:

1. A system for the generation of a signal event comprising in combination:
at least two signal generating apparatus capable of emitting at least one signal, each said signal generating apparatus capable of communicating to other said signal generating apparatus,
whereby activation of one of said at least two signal generating apparatus causes said one of said at least two signal generating apparatus to emit a communication that may be received by other of said at least two signal generating apparatus, causing said one of said at least two signal generating apparatus and said other of said at least two signal generating apparatus to each generate a signal which together comprise a coordinated signal event.

2. The system of claim 1, wherein said at least one signal comprises at least one signal type selected from the group consisting of: an audible signal, a visual signal, a tactile signal.

3. The system of claim 1 wherein each said signal generating apparatus includes at least two active states, said at least two active states including an automatic state wherein said signal generating apparatus will respond to communications from other signal generating apparatus to emit said signal as part of said coordinated signal event, and a manual state wherein said signal generating apparatus will respond to communications from other signal generating apparatus to emit said signal as part of said coordinated signal event when said signal generating apparatus is manually activated by a user during a duration of said coordinated signal event.

4. The system of claim 1 further comprising a master controller apparatus.

5. The system of claim 4 wherein each said signal generating apparatus further includes an externally controlled state in which said signal event may only be initiated by a communication received from said master controller apparatus.

6. The system of claim 5 wherein a communication from said master controller apparatus received by said at least two signal generating apparatus will cause said at least two signal generating apparatus to enter said externally controlled state.

7. A system for the communication of information to a user, comprising:
a first type of signal generating apparatus capable of emitting at least one signal, wherein said first type of signal generating apparatus is capable of communicating to a one or more second type of signal generating apparatus, whereby activation of said one or more second type of signal generating apparatus causes said one or more second type of signal generating apparatus to emit a communication signal to a user wherein said communication signal comprises at least one signal type selected from the group consisting of an audible signal and a visual signal wherein said communication signal type provides information to a user.

8. The system according to claim 7, wherein said first type of signal generating apparatus is a master controller apparatus.

9. The system according to claim 7, wherein said first type of signal generating apparatus is the same as said second type of signal generating apparatus.

10. The system according to claim 7, wherein said second type of signal generating apparatus is further capable of emitting at least one signal capable of communication to other second type of signal generating apparatus whereby activation of said other second type of signal generating apparatus causes said other second type of signal generating apparatus to emit a communication signal to a user wherein said communication signal comprises at least one signal type selected from the group consisting of: an audible signal and a visual signal, wherein said communication signal type provides information to a user.

11. The system according to claim 8, wherein said second type of signal generating apparatus emits at least one signal type selected from a group consisting of: radio frequency waves, infrared light, visible light, ultrasonic sound, and wifi.

12. The system according to claim 7, wherein said first type of signal generating apparatus emits at least one signal type selected from a group consisting of: radio frequency waves, infrared light, visible light, ultrasonic sound, and wifi.

13. The system according to claim 7 wherein said one or more second type of signal generating apparatus further includes an electronic memory device, wherein said electronic memory device stores information whereby said information is provided to the user upon activation of said one or more second type of signal generating apparatus.

14. The system according to claim 13 wherein the electronic memory device is a replaceable memory device.

15. The system according to claim 13 wherein the electronic memory device is mechanically fixed within said one or more second type of signal generating apparatus.

16. The system according to claim 13 wherein said stored information is selected from a group consisting of: a map of a venue location, advertising content, venue activity statistics, venue activity trivia, local hotel contact information, local hotel driving directions, local restaurant contact information, local restaurant ratings, local restaurant driving directions, and games.

17. The system according to claim 16 wherein said stored information is only available to the user for a selected period of time.

18. The system according to claim 13, wherein the electronic memory device comprises a memory device mechanically fixed within said one or more second type of signal generating apparatus and a replaceable memory device wherein said replaceable memory device includes data prepositioned in said replaceable memory device.

19. The system according to claim 13, wherein the information stored in said memory device includes status information whereby the status information causes the second type of signal generating apparatus to provide certain information to the user upon activation of said second type of signal generating apparatus.

20. The system according to claim 13, wherein the information stored in said memory device includes status information whereby the status information causes the second type of signal generating apparatus to provide only selected information to the user upon activation of said second type of signal generating apparatus.

21. The system according to claim 7, wherein said one or more second type of signal generating apparatus includes a receiver for receiving global positioning signals thereby to determine the global position of said one or more second type of signal generating apparatus.

22. The system according to claim 21, further including an electronic memory device wherein said electronic memory device holds stored information wherein said stored information is related to a global position.

23. The system according to claim 22, wherein said determined global position is compared to said stored information and if a match is found said stored information is communicated to the user.

24. The system according to claim 22, wherein said stored information includes routing directions to a place of interest to the user.
